(19) United States
(12) Patent Application Publication
(10) Pub. No.: US 2010/0133032 A1
(43) Pub. Date: Jun. 3, 2010

(54) Device for Controlling Regenerative Braking of Vehicle

(75) Inventors: Sanghyun Jeong, Hwaseong-city (KR); Yeonho Kim, Suwon-city (KR); Seung Ki Kong, Hwaseong-city (KR)

Correspondence Address: MORGAN, LEWIS & BOCKIUS LLP (SF), One Market, Spear Street Tower, Suite 2800, San Francisco, CA, 94105, US

(73) Assignees: HYUNDAI MOTOR COMPANY, Seoul (KR); KIA MOTORS CORPORATION, Seoul (KR)

(21) Appl. No.: 12/511,900

(22) Filed: Jul. 29, 2009

(30) Foreign Application Priority Data
Nov. 28, 2008 (KR) 10-2008-0120113

(51) Int. Cl. B60L 11/12

(52) U.S. Cl. 180/165; 180/65.31

(57) ABSTRACT

A control unit of vehicle is provided including a device for controlling regenerative braking of a vehicle. The device is provided with a drive wheel and a drive motor driving the drive wheel may include a vehicle control unit for calculating a regenerative amount and distributing a target braking force corresponding to the calculated regenerative amount; and a control unit controlling a transmission so that torque of the motor is increased in case of decelerating regeneration of the drive motor.

### CROSS-REFERENCE TO RELATED APPLICATION

The present application claims priority to Korean Patent Application Number 10-2008-0120113 filed on Nov. 28, 2008, the entire contents of which application is incorporated herein for all purposes by this reference.

### BACKGROUND OF THE INVENTION

1. Field of the Invention

The present invention relates to a control unit of a vehicle, and more particularly to a device for controlling regenerative braking of a vehicle.

2. Description of the Related Art

Generally, an electric vehicle is driven by a motor by using electrical energy stored in a battery, and a vehicle using driving torque of the motor as a main power source or an auxiliary power source of the vehicle.

Commonly, the term “electric vehicle” means a vehicle only using electricity, thus distinguishing it from a hybrid vehicle.

In this description, an electric vehicle is illustrated to include an electric vehicle operated by only electricity, and a hybrid vehicle, that is, a vehicle that uses electrical energy stored in a battery as a driving force of the vehicle.

The use of electrical energy generated from a portion of a braking force occurring when braking an electric vehicle has been developed.

That is, a reduction of kinetic energy (i.e., a decrease of drive speed) and generation of electrical energy are performed simultaneously through using a portion of kinetic energy generated by speed of a vehicle as energy for driving a generator.

Firstly, the electric vehicle slows with an electrical braking force because the electric vehicle tends to continue in a straight line when a driver intends to change a direction thereof, and then changes the direction of travel of the vehicle.

The process mentioned above is called plugging, that is, the process transforms electrical energy of the battery to mechanical braking energy so as to brake the electric vehicle.

Further, the method in which the drive motor generates electricity with the inertial force causing torque to be applied thereto, and then the electricity is charged in the battery, is called regenerative braking.

The electrical energy can be generated by a separate generator or by driving the drive motor as a generator in the case of the regenerative braking.

A hydraulic brake system that generates a braking force with hydraulic pressure is also provided to electric vehicles.

This is because there is insufficient braking force developed by means of the process mentioned above, and it does not realize dynamic control of the vehicle since the regenerative braking force is generated only by the drive wheels connected to the motor.

Therefore, a hydraulic pressure braking force via operation of a brake pedal by a driver is added to the regenerative braking force.

Also, as experimental results shown in FIG. 3 according to a prior art in case of shift-control before a vehicle stops, a reverse rotation of the motor occurs in a peripheral portion of “B”.

At this time, oil leakage from inside the automatic transmission owing to the reverse rotation of the motor results in an incapability of control of the transmission, and thereby the durability of the automatic transmission is deteriorated since a shift-shock is excessive.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a device for controlling regenerative braking of vehicle having advantages of improving durability of a transmission and shift feel by inducing motor torque to be increased before a shift process, and by preventing the motor from rotating reversely during a shift process.

In an aspect of the present invention, the device for controlling regenerative braking of a vehicle provided with a drive wheel and a drive motor driving the drive wheel, may include a vehicle control unit for determining a regenerative amount and distributing a target braking force corresponding to the calculated regenerative amount, and a control unit controlling a transmission so that torque of the motor is increased in case of decelerating regeneration of the drive motor.

The decelerating regeneration may be performed during downshift of the vehicle.

The device for controlling regenerative braking of a vehicle may further include a speed sensor detecting a vehicle speed, wherein the control unit controls the transmission so that a speed reduction ratio is increased when the vehicle speed detected by the speed sensor is decreased to a predetermined speed.

The device for controlling regenerative braking of a vehicle may further include a hydraulic pressure brake braking the drive wheel, wherein the control unit increases the force of the hydraulic pressure brake so as to supplement the braking force of the drive wheel while suppressing the regenerative amount during a predetermined period.

In another aspect of the present invention, a device for controlling regenerative braking of a vehicle provided with a drive wheel and a drive motor driving the drive wheel, may include a transmission realizing multiple shift speeds, a vehicle control unit for distributing a target braking force corresponding to a calculated regenerative amount, and a control unit controlling a transmission so that torque of the motor is increased in case of decelerating regeneration of the drive motor, wherein the shift control unit performs duty control in case of engagement control.

In further another aspect of the present invention, a device for controlling regenerative braking of a vehicle, provided with a drive wheel and a drive motor driving the drive wheel, may include a transmission realizing multiple shift-speeds, a vehicle control unit for distributing a target braking force corresponding to a calculated regenerative amount, and a control unit controlling control hydraulic pressure of an engagement element or a release element according to a regenerative torque.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic view of an exemplary device for controlling regenerative braking of a vehicle according to the present invention.

FIG. 2 is a graph of exemplary experimental results according to the present invention.

FIG. 3 is a graph of experimental results according to the prior art.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

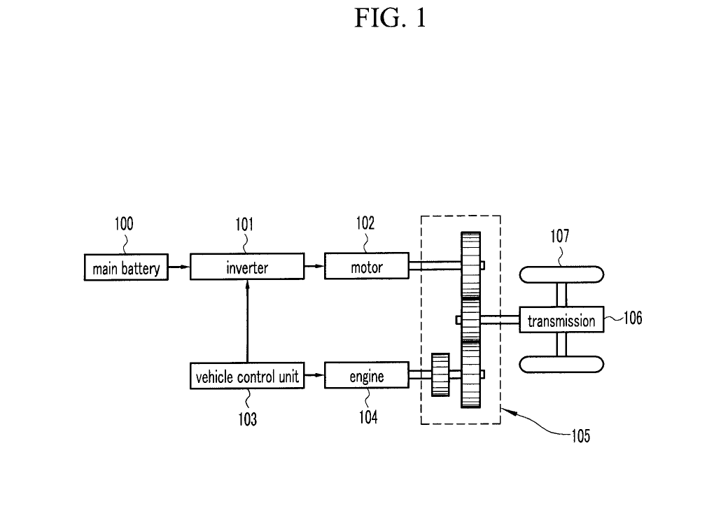

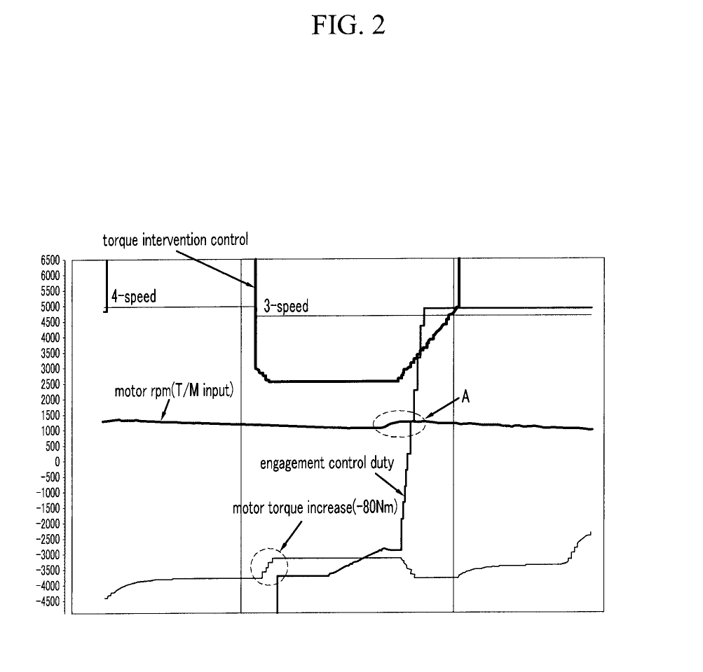

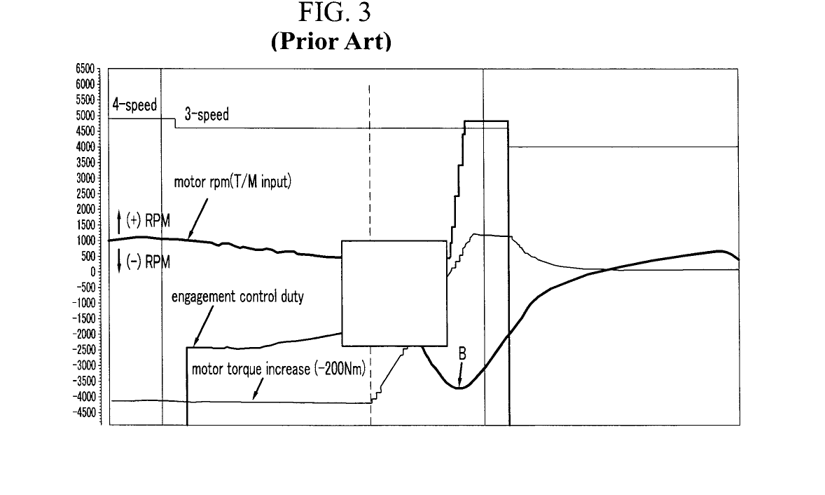

FIG. 1 is a schematic view of a device for control of regenerative braking of a vehicle according to various embodiments of the present invention, FIG. 2 is a graph of experimental results according to various embodiments of the present invention, and FIG. 3 is a graph of experimental results according to a prior art.

Referring to FIG. 1, a conventional hybrid vehicle of a parallel type adapted to various embodiments of the present invention will be explained schematically hereinafter.

Conventionally, the hybrid vehicle system includes a main battery 100, an inverter 101, a motor 102, a vehicle control unit 103, an engine 104, a power transmitting portion 105, a transmission 106, and a drive wheel 107.

The main battery 100 may be a conventional capacitor of a fuel cell.

The inverter 101 converts DC voltage from the main battery 100 to AC voltage according to a drive signal of a hybrid electronic control unit (ECU), and then the AC voltage is provided to the motor 102 via a three-phase power line so as to drive the motor 102 in a reverse or regenerative mode.

The motor 102 is operated by the inverter 101, and then outputs a predetermined torque to the transmission 106.

Also, the motor 102 generates an AC voltage with power of the drive wheel 107, and the generated AC voltage is provided to the inverter 101 through the 3-phase power line.

The drive wheel 107 may include a shaft (not indicated) and a tire (not indicated).

The tire is mounted at the shaft so as to be rotated by the power transmitted from the shaft via a power transmitting gear.

Further, the motor 102 includes a rotation speed sensor that outputs a detected rotation speed signal to the vehicle control unit 103.

The vehicle control unit 103 may be a conventional hybrid ECU.

The vehicle control unit 103 generates a shift signal for controlling the transmission 106 so as to increase a speed reduction ratio of the transmission 106 when a reduction of vehicle speed is detected by a brake pedal position.

Further, the vehicle control unit 103 calculates a requested braking force based on the brake pedal position.

The vehicle control unit 103 calculates a regenerative amount of the motor 102 based on rotation speed of the motor 102 received from the requested braking force, state of charge (SOC) of the main battery 100, and rotation speed signal, and thereby further calculates a distribution of the requested braking force of the regenerative amount.

In doing so, the vehicle control unit 103 generates a regenerative signal indicating a calculated distribution, and outputs it to a brake ECU.

The vehicle control unit 103 receives a regenerative admission amount signal from the brake ECU, calculates a potential regenerative amount of the motor 102 based on the regenerative admission amount signal, and further generates a drive signal for driving the inverter 101 so that the motor 102 generates the calculated regenerative amount and outputs it to the inverter 101.

Further, the vehicle control unit 103 sends a signal to an engine control unit regarding power required for output of the engine 104.

The engine control unit drives the engine 104 so that the engine 104 outputs power ordered by the vehicle control unit 103.

More specifically, the engine control unit drives the engine 104 so as to output a predetermined power by controlling a fuel injection amount and engine speed.

Hereinafter, a device for control of regenerative braking of a vehicle according to various embodiments of the present invention will be described in detail.

Firstly, a motor control unit determines whether a reverse rotation of the motor 102 has occurred in a shifting process of vehicle.

At this time, if the reverse rotation of the motor 102 is determined, an amount of increase of motor torque is controlled to be further increased.

As shown in FIG. 2, for example, during a 4-speed 3-speed down-shift process, a motor torque increase (i.e. torque intervention) is realized, and engagement duty of the transmission 106 is increased in order to complete the shifting process.

Referring to the “A” portion in FIG. 2, the engine speed is decreased somewhat due to increase of the motor torque, and thereby a reverse rotation of the motor 102 is prevented.

Therefore, shift feel may be improved by preventing a shift shock caused by the reverse rotation of the motor 102.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A device for controlling regenerative braking of a vehicle provided with a drive wheel and a drive motor driving the drive wheel, the device comprising:
a vehicle control unit for determining a regenerative amount and distributing a target braking force corresponding to the calculated regenerative amount; and
a control unit controlling a transmission so that torque of the motor is increased in case of decelerating regeneration of the drive motor.

2. The device of claim 1, wherein the decelerating regeneration is performed during downshift of the vehicle.

3. The device of claim 1, further comprising a speed sensor detecting a vehicle speed,
wherein the control unit controls the transmission so that a speed reduction ratio is increased when the vehicle speed detected by the speed sensor is decreased to a predetermined speed.

4. The device of claim 1, further comprising a hydraulic pressure brake braking the drive wheel,
wherein the control unit increases the force of the hydraulic pressure brake so as to supplement the braking force of the drive wheel while suppressing the regenerative amount during a predetermined period.

5. A device for controlling regenerative braking of a vehicle provided with a drive wheel and a drive motor driving the drive wheel, the device comprising:
a transmission realizing multiple shift speeds;
a vehicle control unit for distributing a target braking force corresponding to a calculated regenerative amount; and
a control unit controlling a transmission so that torque of the motor is increased in case of decelerating regeneration of the drive motor.

6. The device of claim 5, wherein
the shift control unit performs duty control in case of engagement control.

7. A device for controlling regenerative braking of a vehicle, provided with a drive wheel and a drive motor driving the drive wheel, comprising:
a transmission realizing multiple shift-speeds;
a vehicle control unit for distributing a target braking force corresponding to a calculated regenerative amount; and
a control unit controlling control hydraulic pressure of an engagement element or a release element according to a regenerative torque.
